(19) United States
(12) Patent Application Publication
(10) Pub. No.: US 2018/0349879 A1
(43) Pub. Date: Dec. 6, 2018

(54) SYSTEMS AND METHODS TO ENABLE ROBOTIC NODE PARTICIPATION IN PEER-TO-PEER COMMERCIAL TRANSACTIONS

(71) Applicant: Walmart Apollo, LLC, Bentonville, AR (US)

(72) Inventors: Donald R. High, Noel, MO (US); Bruce W. Wilkinson, Rogers, AR (US); Todd D. Mattingly, Bentonville, AR (US)

(21) Appl. No.: 15/993,312

(22) Filed: May 30, 2018

Related U.S. Application Data
(60) Provisional application No. 62/513,203, filed on May 31, 2017.

(51) Int. Cl. G06Q 20/22; H04L 29/08; H04L 9/06; G06Q 20/38

(52) U.S. Cl. CPC G06Q 20/223; G06Q 20/3827; H04L 9/0643; H04L 67/104

(57) ABSTRACT

In some embodiments, systems and methods are provided herein useful to enable a robotic node to participate in peer-to-peer commercial transactions. In some embodiments, the system includes a plurality of databases each comprising information dictating a version of a distributed ledger comprising a commercial agreement, the commercial agreement comprising a contract provision. The robotic node includes a control circuit communicatively coupled to a database of the plurality of databases. The control circuit accesses a commercial agreement in a version of the distributed ledger using a cryptographic key for the commercial agreement and thereby causes the robotic node to activate a robotic node functionality to facilitate performance of the contract provision. The control circuit causes the robotic node to modify the robotic node functionality when a violation of the contract provision is identified.

### CROSS-REFERENCE TO RELATED APPLICATION

This application claims the benefit of U.S. Provisional Application No. 62/513,203, filed May 31, 2017, which is incorporated by reference in its entirety herein.

### TECHNICAL FIELD

This invention relates generally to enable autonomous vehicle participation in peer-to-peer commercial transactions.

### BACKGROUND

Commercial transactions can be defined as interactions between two or more parties in which information is exchanged, and in some instances in which goods, services or something of value is exchanged for some type of remuneration. Further, some transactions may be governed by legally binding agreements (“commercial agreements”) between parties that are obligated to do or restrain from doing particular things. Commercial agreements are typically written, verbal, or implied in a formal or an informal manner.

### BRIEF DESCRIPTION OF THE DRAWINGS

Disclosed herein are embodiments of systems, apparatuses and methods pertaining enabling robotic nodes to participate in peer-to-peer commercial transactions. This description includes drawings, wherein:

FIG. 1 comprises an illustration of blocks as configured in accordance with various embodiments of these teachings;

FIG. 2 comprises an illustration of blockchain based transactions in accordance with various embodiments of these teaching.

FIG. 3 comprises an illustration of transactions configured in accordance with various embodiments of these teachings;

FIG. 4 comprises a flow diagram in accordance with various embodiments of these teachings;

FIG. 5 comprises a process diagram as configured in accordance with various embodiments of these teachings;

FIG. 6 comprises a system diagram configured in accordance with various embodiments of these teachings;

FIG. 7 illustrates a simplified block diagram of a system configured in accordance with some embodiments.

FIG. 8 comprises a process diagram as configured in accordance with various embodiments of these teachings

FIG. 9 is a flowchart of an exemplary process as configured in accordance with various embodiments of these teachings.

FIG. 10 illustrates an exemplary system for use in implementing methods, techniques, devices, apparatuses, systems, servers, sources and enabling robotic node participation in peer-to-peer commercial transactions in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments,” “various embodiments,” “an implementation,” “some implementations,” “some applications,” or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems and methods are provided herein useful to enable robotic nodes to participate in peer-to-peer commercial transactions. In some embodiments, the system may include a plurality of databases each comprising information dictating one or more versions of a distributed ledger that each can include one or more commercial agreements, where each commercial agreement may include one or more contract provisions. The robotic node can include one or more first control circuits each communicatively coupled to one or more first databases included in the plurality of databases, where each first database can include a first version of the distributed ledger. The one or more control circuits can be configured to access one or more commercial agreements included in the first version of the distributed ledger using one or more cryptographic key each configured for use with a particular accessed commercial agreement. Accessing the commercial agreement typically causes the robotic node to activate one or more robotic node functionalities to facilitate performance of the one or more contract provisions dictated by the accessed commercial agreement. Each cryptographic key can be received from a second control circuit located external to the robotic node and associated with a party of the accessed commercial agreement.

In some embodiments, methods are provided for monitoring robotic node participation in peer-to-peer commercial transactions. Some of these methods can access, through a robotic node participating in a peer-to-peer commercial transaction, one or more commercial agreements included in one or more distributed ledgers using one or more cryptographic keys each unique to a particular accessed commercial agreement. Each cryptographic key can be received from one or more second control circuits that are located external to the robotic node and associated with at least one party of the accessed commercial agreement. Each commercial agreement can include one or more contract provisions. The robotic node can be caused to activate one or more robotic node functionalities to facilitate one or more acts in performance of the one or more contract provisions. The robotic node can further be caused to modify one or more of the robotic node functionalities when a violation of one or more of the contract provisions is identified

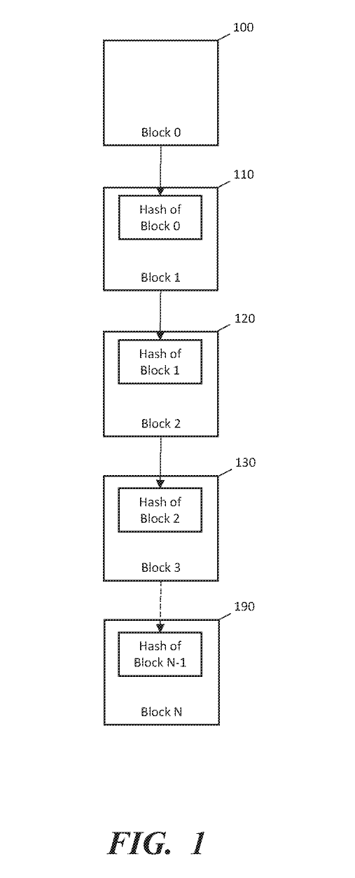

Descriptions of some embodiments of blockchain technology are provided with reference to FIG. 1-6 herein. In some embodiments of the invention described above, blockchain technology may be utilized to record information related to commercial transactions (e.g., sales record, delivery record, transactions, etc.). One or more of the user devices described herein may comprise a node in a distributed blockchain system storing a copy of the blockchain record. Updates to the blockchain may comprise transfer of items/sales/new data and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of being kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 1, an illustration of a blockchain according to some embodiments is shown. In some embodiments, a blockchain comprises a hash chain or a hash tree in which each block added in the chain contains a hash of the previous block. In FIG. 1, block 0 100 represents a genesis block of the chain. Block 1 110 contains a hash of block 0 100, block 2 120 contains a hash of block 1 110, block 3 130 contains a hash of block 2 120, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners’ are nodes that compete to provide proof-of-work to form a new block, and the first successful miner of a new block earns Bitcoin currency in return.

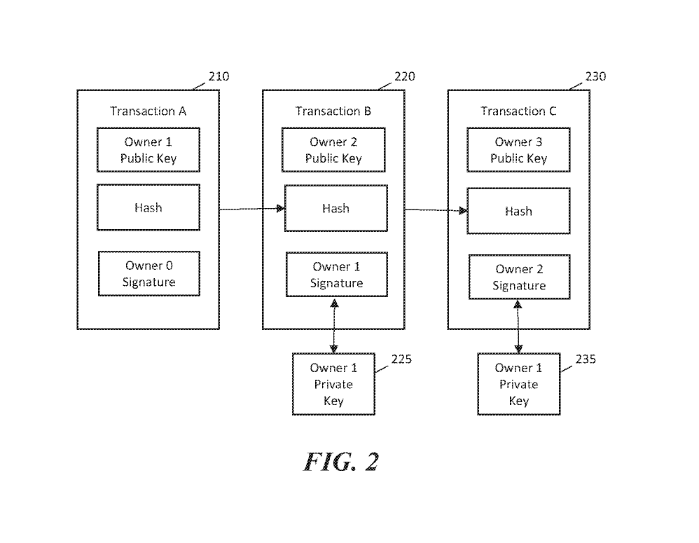

Now referring to FIG. 2, an illustration of blockchain based transactions according to some embodiments is shown. In some embodiments, the blockchain illustrated in FIG. 2 comprises a hash chain protected by private/public key encryption. Transaction A 210 represents a transaction recorded in a block of a blockchain showing that owner 1 (recipient) obtained an asset from owner 0 (sender). Transaction A 210 contains owner's 1 public key and owner 0's signature for the transaction and a hash of a previous block. When owner 1 transfers the asset to owner 2, a block containing transaction B 220 is formed. The record of transaction B 220 comprises the public key of owner 2 (recipient), a hash of the previous block, and owner 1's signature for the transaction that is signed with the owner 1's private key 225 and verified using owner 1's public key in transaction A 210. When owner 2 transfers the asset to owner 3, a block containing transaction C 230 is formed. The record of transaction C 230 comprises the public key of owner 3 (recipient), a hash of the previous block, and owner 2's signature for the transaction that is signed by owner 2's private key 235 and verified using owner 2's public key from transaction B 220. In some embodiments, when each transaction record is created, the system may check previous transaction records and the current owner's private and public key signature to determine whether the transaction is valid. In some embodiments, transactions are broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 2 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

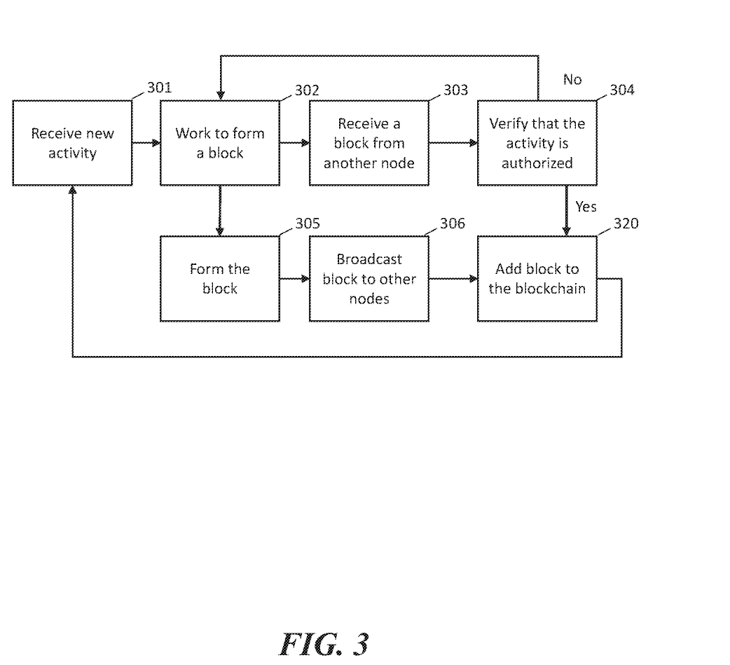

Now referring to FIG. 3, a flow diagram according to some embodiments is shown. In some embodiments, the steps shown in FIG. 3 may be performed by a processor-based device, such as a computer system, a server, a distributed server, a timestamp server, a blockchain node, and the like. In some embodiments, the steps in FIG. 3 may be performed by one or more of the nodes in a system using blockchain for record keeping.

In step 301, a node receives a new activity. The new activity may comprise an update to the record being kept in the form of a blockchain. In some embodiments, for blockchain supported digital or physical asset record keeping, the new activity may comprise an asset transaction. In some embodiments, the new activity may be broadcasted to a plurality of nodes on the network prior to step 301. In step 302, the node works to form a block to update the blockchain. In some embodiments, a block may comprise a plurality of activities or updates and a hash of one or more previous blocks in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 302, if the node successfully forms a block in step 305 prior to receiving a block from another node, the node broadcasts the block to other nodes over the network in step 306. In some embodiments, in a system with incentive features, the first node to form a block may be permitted to add incentive payment to itself in the newly formed block. In step 320, the node then adds the block to its copy of the blockchain. In the event that the node receives a block formed by another node in step 303 prior to being able to form the block, the node works to verify that the activity recorded in the received block is authorized in step 304. In some embodiments, the node may further check the new block against system consensus rules for blocks and activities to verify whether the block is properly formed. If the new block is not authorized, the node may reject the block update and return to step 302 to continue to work to form the block. If the new block is verified by the node, the node may express its approval by adding the received block to its copy of the blockchain in step 320. After a block is added, the node then returns to step 301 to form the next block using the newly extended blockchain for the hash in the new block.

In some embodiments, in the event one or more blocks having the same block number are received after step 320, the node may verify the later arriving blocks and temporarily store these blocks if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 301.

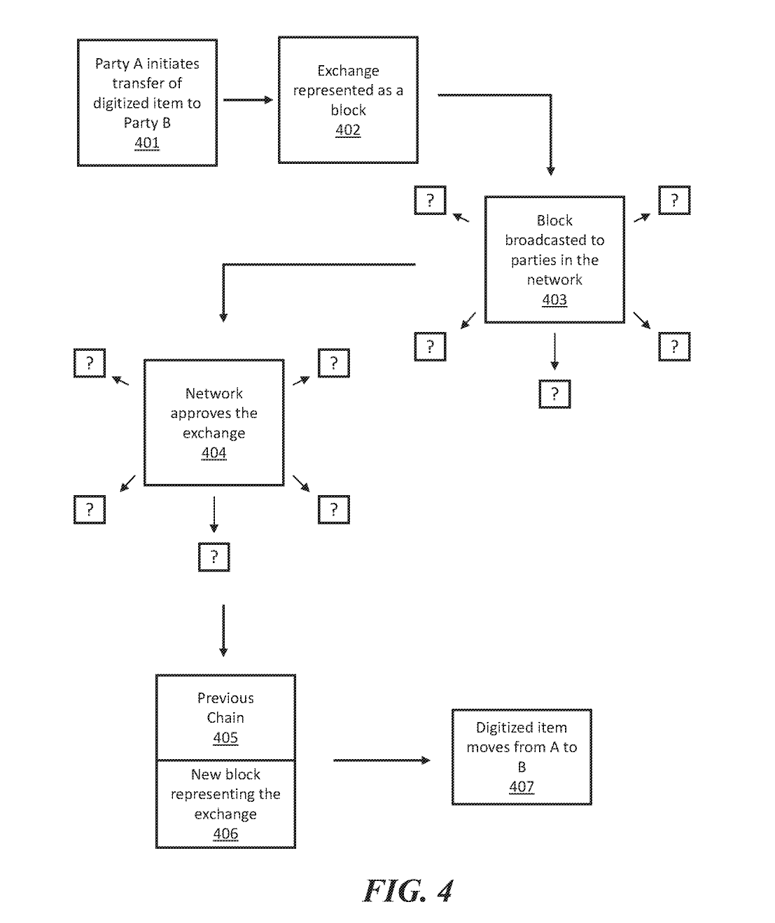

Now referring to FIG. 4, a process diagram of a blockchain update according to some implementations is shown. In step 401, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 402, the exchange initiated in step 401 is represented as a block. In some embodiments, the transaction may be compared with transaction records in the longest chain in the distributed system to verify Party A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide proof of work to form the block may earn a Bitcoin. In some embodiments, a block may comprise one or more transactions between different parties that are broadcasted to the nodes. In step 403, the block is broadcast to parties in the network. In step 404, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g., party A is in possession of the asset he/she seeks to transfer). In some embodiments, a block may be approved with consensus of the nodes in the network. After a block is approved, the new block 406 representing the exchange is added to the existing chain 405 comprising blocks that chronologically precede the new block 406. The new block 406 may contain the transaction(s) and a hash of one or more blocks in the existing chain 405. In some embodiments, each node may then update their copy of the blockchain with the new block and continue to work on extending the chain with additional transactions. In step 407, when the chain is updated with the new block, the digitized item is moved from party A to party B.

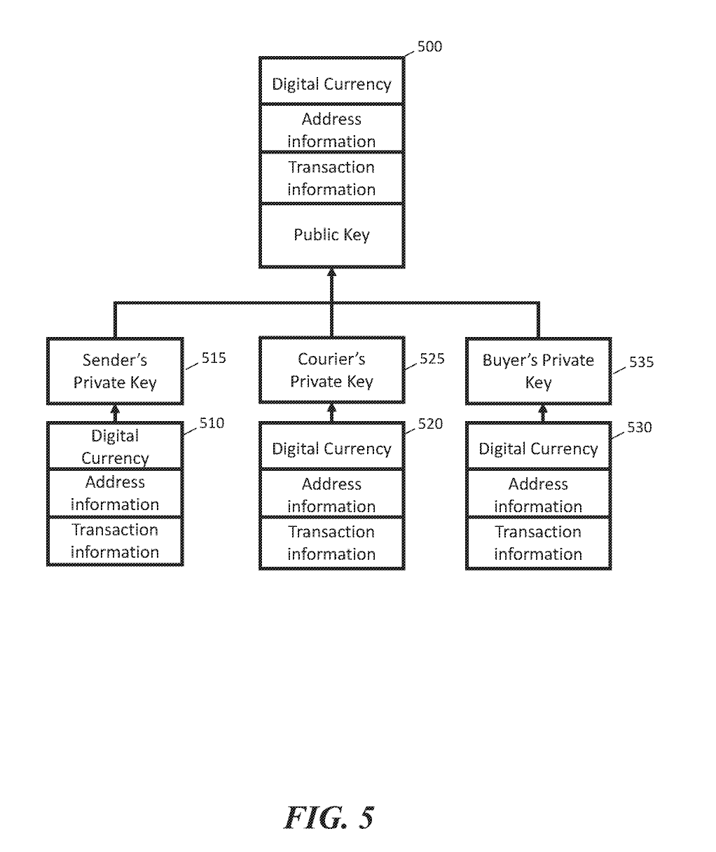

Now referring to FIG. 5, a diagram of a blockchain according to some embodiments is shown. FIG. 5 comprises an example of an implementation of a blockchain system for delivery service record keeping. The delivery record 500 comprises digital currency information, address information, transaction information, and a public key associated with one or more of a sender, a courier, and a buyer. In some embodiments, nodes associated with the sender, the courier, and the buyer may each store a copy of the delivery record 510, 520, and 530 respectively. In some embodiments, the delivery record 500 comprises a public key that allows the sender, the courier, and/or the buyer to view and/or update the delivery record 500 using their private keys 515, 525, and 535, respectively. For example, when a package is transferred from a sender to the courier, the sender may use the sender's private key 515 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcast and verified by the sender, the courier, the buyer, and/or other nodes on the system before being added to the distributed delivery record blockchain. When the package is transferred from the courier to the buyer, the courier may use the courier's private key 525 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcast and verified by the sender, the courier, the buyer, and/or other nodes on the system before being added to the distributed delivery record blockchain.

With the scheme shown in FIG. 5, the delivery record may be updated by one or more of the sender, courier, and the buyer to form a record of the transaction without a trusted third party while preventing unauthorized modifications to the record. In some embodiments, the blockchain-based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

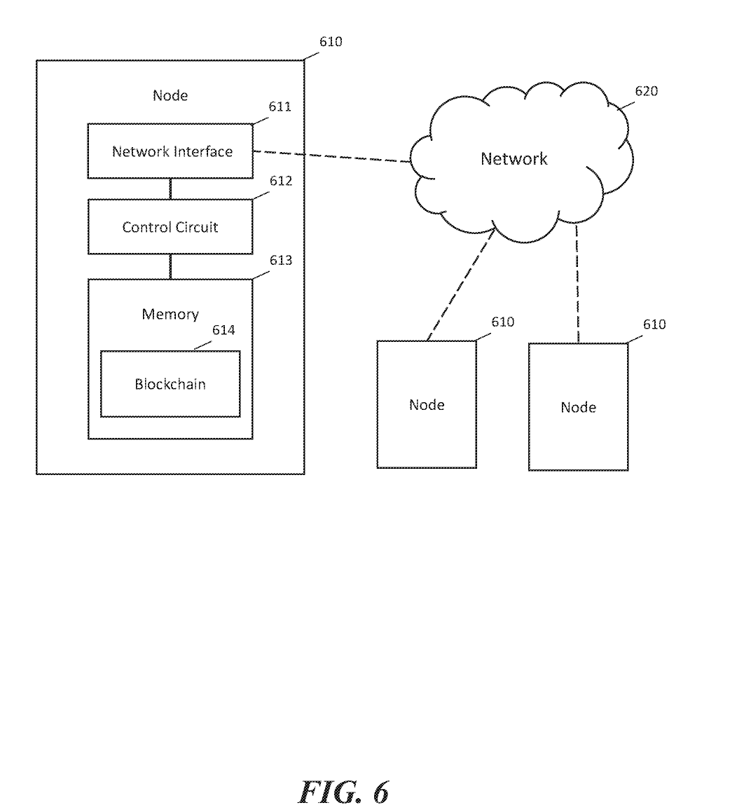

Now referring to FIG. 6, a system according to some embodiments is shown. A distributed blockchain system comprises a plurality of nodes 610 communicating over a network 620. In some embodiments, the nodes 610 may comprise a distributed blockchain server and/or a distributed timestamp server. In some embodiments, one or more nodes 610 may comprise or be similar to a “miner” device on the Bitcoin network. Each node 610 in the system comprises a network interface 611, a control circuit 612, and a memory 613.

The control circuit 612 may comprise a processor, a microprocessor, and the like and may be configured to execute computer readable instructions stored on a computer readable storage memory 613. The computer readable storage memory may comprise volatile and/or non-volatile memory and have stored upon it a set of computer readable instructions which, when executed by the control circuit 612, causes the node 610 to update the blockchain 614 stored in the memory 613 based on communications with other nodes 610 over the network 620. In some embodiments, the control circuit 612 may further be configured to extend the blockchain 614 by processing updates to form new blocks for the blockchain 614. Generally, each node may store a version of the blockchain 614, and together, may form a distributed database. In some embodiments, each node 610 may be configured to perform one or more steps described with reference to FIGS. 3-4 herein.

The network interface 611 may comprise one or more network devices configured to allow the control circuit to receive and transmit information via the network 620. In some embodiments, the network interface 611 may comprise one or more of a network adapter, a modem, a router, a data port, a transceiver, and the like. The network 620 may comprise a communication network configured to allow one or more nodes 610 to exchange data. In some embodiments, the network 620 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. Consequently, sellers are protected from fraud and buyers are protected by the routine escrow mechanism.

In some embodiments, a blockchain may be used to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain-based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

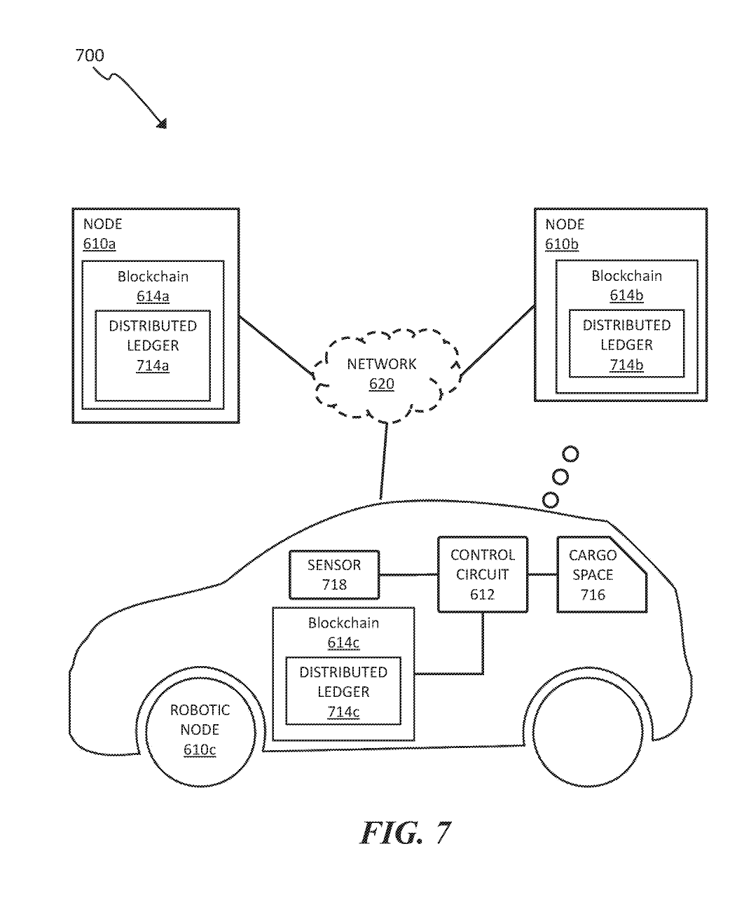

Now referring to FIG. 7, a system to enable the monitoring robotic node participation in peer-to-peer commercial transactions as configured according to some embodiments is shown. In some embodiments, the term “peer-to-peer transactions” refers to party-to-party transactions involving commercial agreements where one or more parties to the commercial agreement are each represented by a particular node 610 that acts in a representative capacity on behalf thereof. In various embodiments, a “party” can refer to one or more persons, one or more corporations, or a combination thereof. In some embodiments, the term “commercial agreements” describes legally binding contracts (i.e., a commercial agreement consciously made by the parties that indicates which actions are henceforth required and/or prohibited) between two or more parties (e.g., humans, corporations, or a combination thereof) and typically include an offer (i.e., a promise in exchange for performance by another party), an acceptance of the offer (i.e., an agreement to perform), and consideration (i.e. performance of a service/act for a predetermined time in return for a compensatory reward that may not always be monetary in nature). In some embodiments, one or more nodes 610 can be a machine (e.g., an apparatus using or applying mechanical power and having several parts, each with a definite function and together performing one or more particular tasks) configured to perform actions autonomously and/or semi-autonomously (i.e. a robotic node). In various embodiments, a robotic node is an autonomous and/or semi-autonomous machine having a plurality of motors that facilitate movement of the robotic node on two or more axes.

In general, each party may be bound by one or more contract provisions that each specify one or more parties to perform a particular task and/or service by a specified time or prevents one or more parties from performing a particular task and/or service for a specified time. One or more “contract provisions” or “provisions” are typically prescribed in commercial agreements. In general, parties that are responsible for a particular provision can be held in breach of contract when the particular provision is not performed as prescribed in the commercial agreement. As described herein using FIGS. 7-10, the robotic nodes 610 can be configured to participate in a commercial agreement, monitor the performance of one or more contract provisions of the commercial agreement, and respond in one or more particular manners when a performance violates the one or more contract provisions.

The system 700 can include one or more nodes 610a, nodes 610b, and robotic nodes 610c communicating over a computer and/or one or more communication networks 620. The nodes 610a, nodes 610b, and robotic nodes 610c can each perform one or more of the functionalities of nodes 610 as well as include one or more characteristics and/or components thereof (e.g., network interface 611, a control circuit 612, a memory 613, etc.). In some embodiments, one or more of the nodes 610a, nodes 610b, and robotic nodes 610c can each store a version of distributed ledger 714 in their respective versions of blockchain 614. One or more of the nodes 610a, nodes 610b, and robotic nodes 610 may be configured to perform one or more steps described with reference to FIGS. 7-10.

The distributed ledgers 714 can each include information that dictates one or more commercial agreements each involving one or more robotic nodes 610c, one or more additional parties, or a combination of two or more thereof. In some embodiments, one or more of the nodes 610 can be configured to function as objects and/or components defined in the contract provisions. In some embodiments, the robotic nodes 610c can be autonomous and/or semi-autonomous mechanical platforms that can be configured to perform one or more tasks and/or services. For example, the one or more tasks and/or services can include industrial tasks (e.g., welding, mixing, lifting, pouring, cutting, sewing, bonding, as well as carrying, pushing, pulling, towing, stacking or tiering materials, similar industrial tasks, or a combination of two or more thereof). In various embodiments, the robotic nodes 610c can be articulated robots, Selective Compliance Assembly Robot Arm (SCARA) robots, delta robots, Cartesian coordinate robots, similar industrial robots, or a combination of two or more thereof. In some embodiments, nodes 610 can include computing devices (e.g., desktop computers, laptop computers, mobile devices, thin clients, etc. that can be associated with contracting parties, consumers, physical locations, etc.), that are used by a party to enter into one or more commercial agreements. In some embodiments, one or more nodes 610 can be configured as a robotic node as defined herein.

In some embodiments, the robotic nodes 610c can be configured to traverse environments via the use of one or more terrestrial propulsion systems, aerial propulsion systems, aquatic propulsion systems, similar propulsion systems, or a combination of two or more thereof. By one approach, the robotic nodes 610c can be one or more terrestrial vehicles (e.g., wagons, cars, motorcycles, trucks, buses, tractor trailers, tanks, tracked vehicles, trains, trams, and similar terrestrial vehicles), aerial vehicles (e.g., airplanes, helicopters, unmanned aerial vehicles (UAV), tilt-wing aircrafts, and similar aerial vehicles), aquatic vehicles (e.g., ships, boats, hovercrafts, submarines, and similar aquatic vehicles), interstellar vehicles (e.g., any vehicle or machine having a propulsion system that can be configured to operate at approximately 50 miles in altitude and beyond), industrial vehicles (e.g., any mechanical platform used to carry, push, pull, lift, tow, stack or tier materials, and/or similar tasks), similar vehicles, or a combination of two or more thereof. In various embodiments, the robotic nodes 610c can be mobile robots, service robots, educational robots, modular robots, collaborative robots, similar robotic platforms, or a combination of two or more thereof. The robotic nodes 610c can be powered by gasoline, electricity, hydrogen, solar energy, similar energy sources, or a combination of two or more thereof.

Robotic nodes 610c, can have one or more cargo spaces 716, which can each be a three-dimensional volume configured to store and/or transport one or more persons, objects, sets of objects, or a combination of two or more thereof for a predetermined duration. The cargo spaces 716 can include trunk spaces, cabin spaces, frunks, trailer spaces, glove compartments, storage areas, and/or similar spaces, or a combination thereof. In certain embodiments, the cargo spaces 716 can include climate control capabilities (e.g., temperature, humidity, and/or pressure control) and be configured to maintain climatic conditions as dictated by the commercial agreement.

In some embodiments, contract provisions of a commercial agreement can be monitored to ensure the proper performance thereof. For example, the robotic nodes 610c can include one or more sensors 718 that can be configured to capture data about performance of the one or more contract provisions. By one approach, sensors 718 can be sensors 1026. In some embodiments, one or more of the robotic nodes 610c can be configured to perform one or more tasks/services as dictated by one or more contract provisions of a commercial agreement included in one or more versions of the distributed ledgers 714 where the robotic node 610c can activate one or more robotic node functionalities to facilitate performance of the one or more tasks/services. For example, robotic node functionalities can include navigation services, domestic tasks (e.g., shopping, cooking, food preparation, cleaning, similar domestic tasks), and industrial tasks (e.g., machining, lifting, moving, welding, sewing, mixing, similar industrial tasks, or a combination of two or more thereof) or a combination thereof. In general, the one or more sensors 718 can be positioned about the robotic nodes 610c in any manner that facilitates the capture of data associated with one or more robotic node functionalities.

In some embodiments, the sensors 718 can be configured to capture data about the one or more robotic node functionalities that facilitate one or more contract provisions. In some embodiments, data captured by the sensors 718 can be transmitted to other nodes 610 for verification. Data captured by the sensors 718 can be used to ascertain the status of the performance of one or more particular contract provisions facilitated by the one or more robotic node functionalities. For example, contract provisions can be considered “violated” when not performed as prescribed by the contract provision or “satisfied” when performed as prescribed. In some embodiments, the status of a contract provision can be verified by comparing the data captured by the sensors 718 to details dictated by the contract provision. For example, one or more of the robotic node functionalities that facilitate a particular contract provision may be modified to restrict, diminish, lessen, minimize, or reduce the continuance of the violation when the contract provision is violated. In some embodiments, the violation of a contact provision can be overridden when the party that receives the benefit of the performance of the contract provision acknowledges the violation as a nonbreaching action. By one approach, receipt of the acknowledgment can cause the robotic functionality to be returned to its pre-modified state.

In some embodiments, the sensors 718 can capture climatic data (e.g., temperature, humidity, barometric pressure, similar climatic data, and/or a combination of two or more thereof), accelerometer data (e.g., speed, velocity, pace, momentum, etc.), geospatial data (e.g., to determine locations, paths, routes, etc.), pressure data (e.g., weight values) similar data associated with one or more robotic node functionalities of the robotic nodes 610c. In some embodiments, the sensors 718 can capture biometric data (e.g., physiological and/or behavioral characteristics) of one or more persons that are positioned within a threshold distance of the robotic nodes 610 to determine whether the capture biometric data shares a threshold amount of characteristics with one or more known biometric data set to identify one or more particular persons for authentication purposes. The sensors 718 can be configured to capture one or more images of the contents of cargo space 716 and compare the captured images to content prescribed in the provision to determine whether the two sets of data share a threshold amount of visual characteristics (e.g., color, shape, size, orientation, similar characteristics, or a combination of two or more thereof).

By one approach, the robotic nodes 610c can act in a representative capacity for one or more of the parties and activate one or more robotic node functionalities to facilitate performance of one or more contract provisions of the commercial agreement. For example, as an alternative to parties entering into commercial agreements with owners of the robotic nodes 610c parties may enter into commercial agreements directly with the robotic nodes 610c for the use of one or more services/functionalities of the robotic nodes 610c for a predetermined time period prescribed in the contract provision. In some embodiments, the robotic nodes 610c acting in a representative capacity on behalf of a party can perform services/tasks as prescribed in the contract provisions and monitor such performances (e.g., to ensure that the robotic node 610c performs the one or more services/tasks as prescribed in the one or more associated contract provisions). In some embodiments, the robotic node 610c can store the binding commercial agreements in distributed ledger 714c as well as in other versions of the distributed ledger 714 (e.g., distributed ledgers 714a and/or 714b) for storage in the respective version of the blockchain 614. In some embodiments, parties represented by the robotic nodes 610c may prescribe the types of commercial agreements and/or a rules-based selection criteria (e.g., party types, compensation amounts/ranges, service/task types, date/time periods, event triggers, conditions for execution, similar criteria, or a combination of two or more thereof) which dictates the conditions under which the robotic nodes 610 can enter into commercial agreements without further input from the owners thereof.

In some embodiments, the rules-based selection criteria can increase the contractual autonomy of the robotic nodes 610c by reducing owner input during contract negotiations. In various embodiments, one or more contract provisions of the commercial agreement can specify one or more nodes 610 as the subject matter and/or focal point thereof (i.e. a place or thing described; hereinafter “provision objects”). In some embodiments, the subject matter of contract provisions can be represented by one or more nodes 610. For example, the nodes 610 can be tangible objects that can be retrieved, summoned, transported, approached, similar acts, or a combination of two or more thereof. In some embodiments, provision objects can be any structure that can receive and/or store objects and/or sets of objects (e.g., buildings, facilities, or portions thereof). In some embodiments, provision objects can be configured to capture and transmit information corresponding to its interaction with other nodes 610, which can utilized to determine the status of the performance of contract provisions.

For example, provision objects may be configured to sense the presence of other nodes 610 and broadcast such information to one or more other nodes 610, which can be used to update their respective version of the commercial agreement. In some embodiments, provision objects may include one or more sensors to capture geospatial information and a transceiver to broadcast such information to one or more other nodes 610 to update the related commercial agreement.

In some embodiments, parties can utilize commercial agreement templates to contract for the use of one or more available functionalities of robotic nodes 610c (e.g., one or more taxi services, delivery services, industrial services, similar functionalities, or a combination of two or more thereof). By one approach, a commercial agreement template can become binding when two or more contracting parties or their robotic node representatives agree to one or more contract provisions included in the commercial agreement template. In some embodiments, binding commercial agreements can be generated as a result of the parties agreeing to one or more contract provisions and transmitting the binding agreement to the robotic node 610c for performance.

Binding commercial agreements can be broadcasted to other nodes for storage in each respective version of distributed ledger 714. The following example is used to illustrate one or more concepts disclosed herein. The party associated with node 610a (“Party A) enters in to a binding commercial agreement (“agreement alpha”) with the robotic node 610c (“Party B”) (e.g., according to one or more rule-based criteria, for example, prescribed by the party represented by the robotic node 610c) that requires the robotic node 610c to transport object 1 from location A to location B via route C whereat the robotic node 610c is to deliver the object 1 to a particular recipient (“Recipient”).

Here, agreement alpha includes several transactions: (transaction A) Party A agrees to provide object 1 to Party B at location A at a first prescribed date and time; (transaction B) Party B agrees to provide object 1 to Recipient at a second prescribed date and time; and (transaction C) in response to the successful conclusion of transaction B, Party A agrees to provide Party B access to a predetermined consideration. In some embodiments, the successful conclusion of transaction B can be identified by confirming the conclusion with other nodes 610 of system 700 (e.g., nodes 610a and/or 610b). Hence, each party is responsible for performing at least one contract provision. Party A is responsible for making object 1 available for pickup by Party B at location A at the prescribed date and time (provision 1) and provide access to the predetermined consideration to Party B upon successful completion of transaction B (provision 2). To satisfy their obligations prescribed in agreement alpha, Party A must perform the acts as prescribed in the provisions 1 and 2 where a violation of provisions 1 and/or 2 by Party A can result in Party A being held in breach of agreement alpha.

Similarly, Party B is responsible for transporting object 1 from location A to location B via route C (provision 3) and delivering object 1 to Recipient at location B at the prescribed date and time (provision 4). To satisfy their contract obligations under agreement alpha, Party B must perform the acts as prescribed in the provisions 3 and 4 where a violation of provision 3 and/or 4 by Party B can result in a breach of agreement alpha by Party B. Contract provisions that are not performed as prescribed typically result in a violation of said contract provision. In some embodiments, the one or more robotic node functionalities that facilitate performance of a particular contract provision can be modified (e.g., when such modifications are agreed to by all contracting parties) in response to detecting a violation of that contract provision. In some embodiments, modified robotic node functionalities can be returned to their pre-modified state when the party receiving the benefit of the performance of the provision acknowledges the violation.

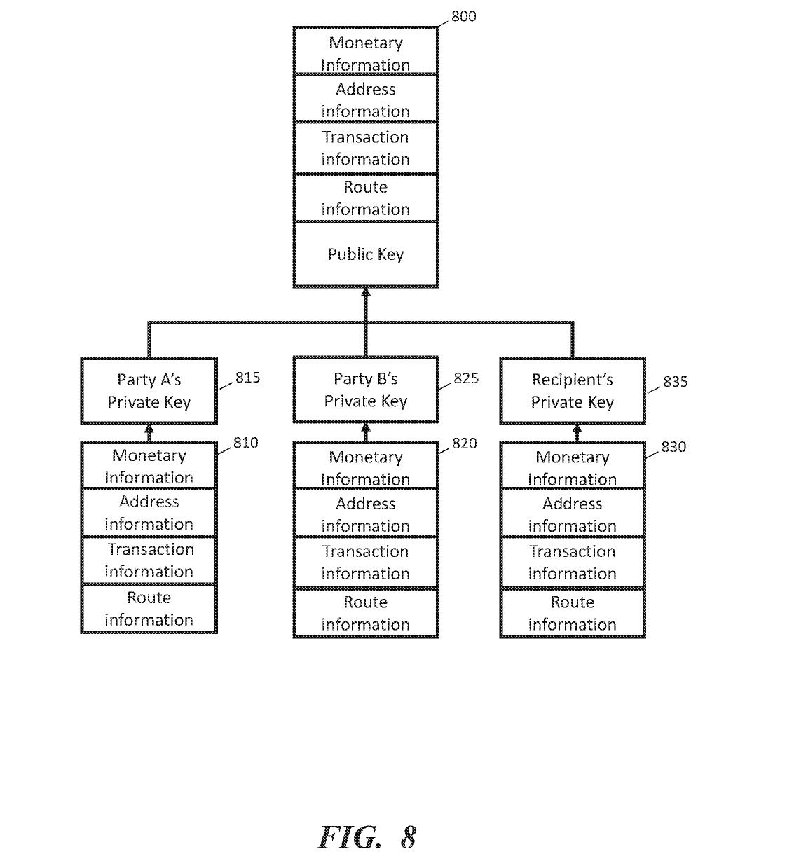

Now referring to FIG. 8, a diagram of a blockchain according to some embodiments is shown. FIG. 8 comprises an example of an implementation of a blockchain system to enable commercial agreement record keeping. The agreement alpha record 800 comprises monetary information, address information, transaction/provision information, and a public key associated with one or more of Party A, Party B, and Recipient. In some embodiments, nodes associated with Party A, Party B, and Recipient may each store a copy of the agreement alpha record 810, 820, and 830, respectively. In some embodiments, the agreement alpha record 800 comprises a public key that allows Party A, the Party B, and/or Recipient to view and/or update the agreement alpha record 800 using their private keys 815, 825, and 835, respectively.

For example, when object 1 is transferred from Party A to Party B, Party A may use Party A's private key 815 to confirm the transfer of object 1 from Party A to Party B and update the agreement alpha record 800 with the new transaction. In some embodiments, the transfer from Party A to Party B may require signatures from both Party A and Party B using their respective private keys. In some embodiments, object 1 can be a node 610 of the system 700 that includes one or more sensors that capture identifying data emitted by Party B (e.g., Media Access Control identifier, mobile device Electronic Serial Number, etc.) and a transceiver to broadcast the captured identifying data to one or more nodes 610 of the system 700 verification. In some embodiments, the compliance of the captured identifying data can be verified by a threshold number of nodes 610. The new transaction may be broadcasted and verified by Party A, Party B, other nodes 610 on the system 700, or a combination of two or more thereof before being added to one or more versions of the distributed ledger 714. In response to the transfer of object 1 from Party B to Recipient at location B, Party B may use the private key 825 to confirm the transfer of object 1 from Party B to Recipient at location B and update the agreement alpha record 800 with the new transaction.

In some embodiments, object 1 can be a node 610 that includes one or more sensors that captures data corresponding to its location and a transceiver to broadcast the captured location data to other nodes in the system 700 for verification (e.g., by confirming that the captured location data has a threshold amount of congruity with route C). When the location data reflects that object 1 traveled from location A to location B via route C, Party A, Party B, other nodes of system 700 or a combination of two or more thereof can update their version of agreement alpha 800 with information corresponding to the successful performance of provision 3. In some embodiments, Recipient may be a node 610 that includes one or more sensors that can capture identifying data emitted by object 1. Here, Recipient can be configured to broadcast the captured identifying data to one or more of the nodes 610 of the system 700 for verification. By one approach, the transfer of object 1 from Party B to Recipient may require signatures from Party B and Recipient using private keys 825 and 835, respectively. Performance of contract provisions 1-4 may each be broadcasted and verified by Party A, Party B, Recipient, other nodes 610 on the system 700 or a combination of two or more thereof before being added to one or more of the distributed ledgers 714a, 714b, and 714c.

With the scheme shown in FIG. 8, the agreement alpha record 800 may be updated by one or more of Party A, Party B, and Recipient to form a record of the performance of provisions 1-4 without a trusted third party while preventing unauthorized modifications to the agreement alpha record 800. In some embodiments, the transactions may further function to allow nodes 610 to function as tangible provision objects of commercial agreements. With the distributed database and peer-to-peer verification of the system 700, contracting parties can each have confidence in the authenticity and accuracy of the agreement alpha record 800 stored in the form of a distributed database.

The robotic nodes 610c can be configured to monitor the performance of the one or more contract provisions that it at least partially facilitates. By one approach, the one or more sensors 718 can be configured to capture data about the robotic node functionalities that can be used to monitor the performance of the one or more contract provisions facilitated by the robotic node functionalities. As discussed above, contract provisions can define one or more conditions or stipulations of acts to be performed and/or not performed as prescribed in commercial agreements. The sensors 718 can capture data that can be used to ascertain the performance and/or non-performance of one or more conditions or stipulations of acts prescribed in one or more contract provisions. For example, climate data associated with cargo space 716 can be captured and compared with prescribed climate conditions dictated by the associated contract provision (e.g., stored in the distributed ledger 714c or another version thereof included in the system 700) to determine whether the captured data is at least within a threshold range of the climate condition as dictated in the contract provision. For example, the threshold range may be prescribed in the associated contract provision. In some embodiments, one or more error notifications can be generated when data captured by the one or more sensors 718 is not within the threshold range as prescribed therein (e.g., of agreement alpha). Using the above referenced example, one or more error notifications can be generated when sensors 718 capture location data about robotic node 610c that reflects that Party B ventured beyond the parameters of route C (e.g., for at least a threshold amount of time) during the transportation of object 1 from location A to location B. One or more error notifications can be generated in response to one or more attempt to deposit cargo within cargo space 716, use a robotic function of robotic node 610c, and/or operate robotic node 610c in a manner that is not prescribed by a contract provision.

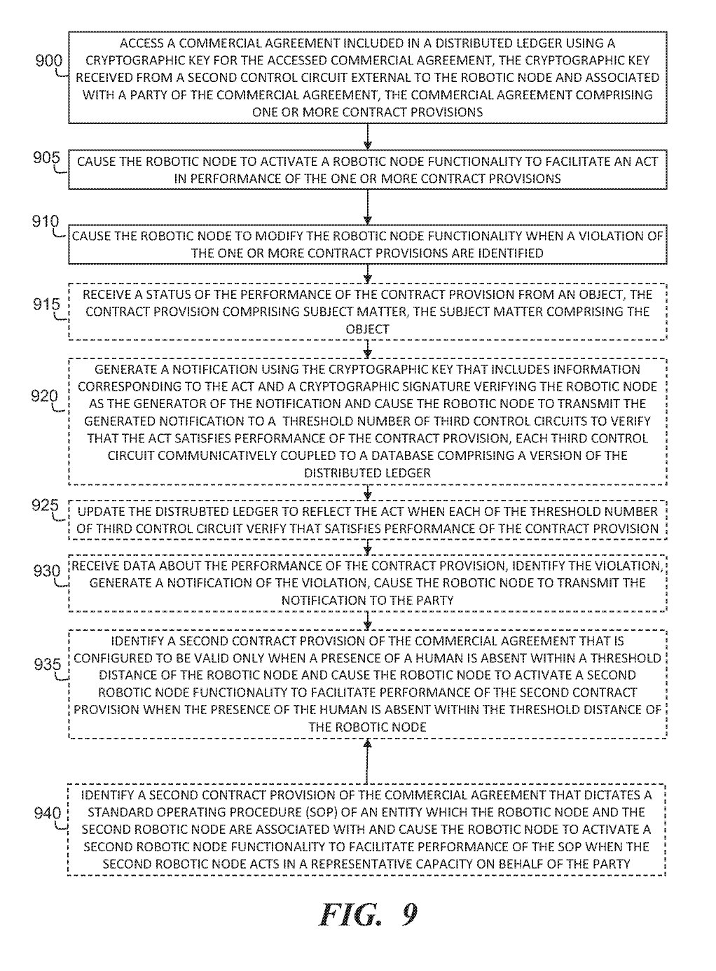

In particular, FIG. 9 illustrated the operation steps of enabling participation of robotic nodes in peer-to-peer transactions, in accordance with some embodiments, a commercial agreement stored in one or more versions of a distributed ledger can be accessed using a cryptographic key associated with the commercial agreement at block 900. The cryptographic key can be received from a second control circuit external to the robotic node and associated with one or more parties of the commercial agreement. The commercial agreement can include one or more contract provisions. The robotic node can be caused to activate one or more robotic node functionalities to facilitate the one or more acts in performance of the one or more contract provisions at block 905. The robotic node can be caused to modify the one or more robotic node functionalities when one or more violations of the one or more contract provisions are identified at block 910. Status of the performance of the one or more contract provisions can be received from one or more objects at block 915. The one or more contract provisions can each include subject matter, where each of the subject matter can include one or more objects that may each be a node that includes a transceiver and can monitor the performance of the one or more contract provisions. In some embodiments, each of the objects can transmit status of the performances to nodes for verification. One or more notifications can be generated at block 920 using the cryptographic key, where each notification includes information corresponding to the act and a cryptographic signature that verifies the robotic node as the generator of the one or more notifications. The robotic node can be caused to transmit the generated notifications to a threshold number of nodes to verify that the act satisfies performance of the contract provision. Each node can be communicatively coupled to one or more databases that each include a version of the distributed ledger. One or more versions of the distributed ledger can be updated to reflect the act when each of the threshold number of nodes verify that satisfies the performance of one or more of the contract provisions at block 925. At block 930, data can be received about the performance of the one or more contract provisions, the one or more violations can be identified, one or more notifications of the violations can be generated, and the robotic node can be caused to transmit the one or more notifications to the party. At block 935, one or more second contract provisions of the commercial agreement can be identified that can be configured to be valid only when a presence of a human is absent within a threshold distance of the robotic node. The robotic node can be caused to activate one or more second robotic node functionalities to facilitate performance of the one or more second contract provisions when the presence of the human is absent within the threshold distance of the robotic node. One or more second contract provisions can be identified at block 940, where each second contract provision can dictate one or more standard operating procedures (“SOP”) of one or more entities which the robotic node and the second robotic node may be associated with. The robotic node can be caused to activate one or more second robotic node functionalities to facilitate performance of the one or more SOPs when a second robotic node acts in a representative capacity on behalf of the party.

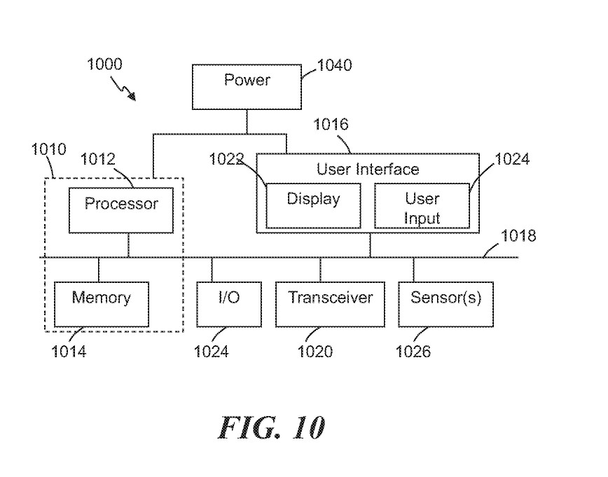

Further, the circuits, circuitry, systems, devices, processes, methods, techniques, functionality, services, servers, sources and the like described herein may be utilized, implemented and/or run on many different types of devices and/or systems. FIG. 10 illustrates an exemplary system 1000 that may be used for implementing any of the components, circuits, circuitry, systems, functionality, apparatuses, processes, or devices of the nodes 610 and/or the control circuit 612 of the robotic node 610c and/or other above or below mentioned systems or devices, or parts of such circuits, circuitry, functionality, systems, apparatuses, processes, or devices. For example, the system 1000 may be used to implement some or all of the robotic node 610c, the control circuit 612, one or more other control circuits and/or processing systems of the robotic node 610c (e.g., video processing systems, image processing systems, sensor data processing systems, emitter system, and the like), one or more remote central control systems, and/or other such components, circuitry, functionality and/or devices. However, the use of the system 1000 or any portion thereof is certainly not required.

By way of example, the system 1000 may comprise a control circuit or processor module 1012, memory 1014, and one or more communication links, paths, buses or the like 1018. Some embodiments may include one or more user interfaces 1016, and/or one or more internal and/or external power sources or supplies 1040. The control circuit 1012 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1012 can be part of control circuitry and/or a control system 1010, which may be implemented through one or more processors with access to one or more memory 613 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1000 may be used to implement one or more of the above or below, or parts of, components, circuits, systems, processes and the like.

The user interface 1016 can allow a user to interact with the system 1000 and receive information through the system. In some instances, the user interface 1016 includes a display 1022 and/or one or more user inputs 1024, such as buttons, touch screen, track ball, keyboard, mouse, etc., which can be part of or wired or wirelessly coupled with the system 1000. Typically, the system 1000 further includes one or more communication interfaces, ports, transceivers 1020 and the like allowing the system 1000 to communicate over a communication bus, a distributed computer and/or communication network 620 (e.g., a local area network (LAN), the Internet, wide area network (WAN), etc.), communication link 1018, other networks or communication channels with other devices and/or other such communications or combination of two or more of such communication methods. Further the transceiver 1020 can be configured for wired, wireless, optical, fiber optical cable, satellite, or other such communication configurations or combinations of two or more of such communications. Some embodiments include one or more input/output (I/O) ports 1034 that allow one or more devices to couple with the system 1000. The I/O ports can be substantially any relevant port or combinations of ports, such as but not limited to USB, Ethernet, or other such ports. The I/O interface 1034 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1026 to provide information to the system and/or sensor information that is communicated to another component, such as the central control system, control circuits 612, another node 610, etc. One or more sensors 1026 can be implemented through one or more sensors 718. The sensors can include substantially any relevant sensor, such as distance measurement sensors (e.g., optical units, sound/ultrasound units, etc.), cameras, motion sensors, inertial sensors, climate sensors (e.g., temperature, humidity, pressure, etc.), accelerometers, impact sensors, pressure sensors, geopositional sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1000 comprises an example of a control and/or processor-based system with the control circuit 1012. Again, the control circuit 1012 can be implemented through one or more processors, controllers, central processing units, logic, software and the like. Further, in some implementations the control circuit 1012 may provide multiprocessor functionality.

The memory 1014, which can be accessed by the control circuit 1012, typically includes one or more processor readable and/or computer readable media accessed by at least the control circuit 1012, and can include volatile and/or nonvolatile media, such as RAM, ROM, EEPROM, flash memory and/or other memory technology. Further, the memory 1014 is shown as internal to the control system 1010; however, the memory 1014 can be internal, external or a combination of internal and external memory. Similarly, some or all of the memory 1014 can be internal, external or a combination of internal and external memory of the control circuit 1012. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 620. The memory 1014 can store code, software, executables, scripts, data, content, lists, programming, programs, log or history data, blockchains, commercial agreements, product information, and the like. While FIG. 10 illustrates the various components being coupled together via a bus, it is understood that the various components may actually be coupled to the control circuit and/or one or more other components directly.

In some embodiments, systems are provided to enable robotic nodes to participate in peer-to-peer commercial transactions. The system may include a plurality of databases each comprising information dictating one or more versions of a distributed ledger each including one or more commercial agreements, where each commercial agreement comprises one or more contract provisions. The robotic node can include one or more first control circuits each communicatively coupled to one or more first databases included in the plurality of databases, where each first database includes a first version of the distributed ledger. The one or more control circuits can be configured to access a commercial agreement included in the first version of the distributed ledger using a cryptographic key configured for use with the accessed commercial agreement and thereby cause the robotic node to activate one or more robotic node functionalities to facilitate performance of the one or more contract provisions. The cryptographic key can be received from a second control circuit located external to the robotic node and associated with a party of the commercial agreement.

The one or more control circuits can also be configured to cause the robotic node to modify one or more of the robotic node functionalities when a violation of the contract provision is identified. By one approach, the subject matter of one or more of the contract provisions can include one or more objects. Each object can include one or more transceivers and one or more third control circuits communicatively coupled to the one or more transceivers as well as one or more third databases included in the plurality of databases. The one or more third control circuits can be configured to monitor the performance of the one or more contract provisions and use the one or more transceivers to transmit a status of the performance to a threshold number of fourth control circuits to verify performance of the one or more contract provisions. Each fourth control circuit can be communicatively coupled to one or more fourth databases of the plurality of databases.

In some embodiments, a transceiver can be communicatively coupled to the one or more first control circuits. The first control circuits can be configured to generate one or more notifications using the cryptographic key that can include information corresponding to a cryptographic signature verifying the robotic node as a source of the generated notifications. The first control circuits can be configured to cause the robotic node to use the transceiver(s) to transmit the generated notification to a threshold number of third control circuits to verify performance of the one or more contract provisions, each third control circuit communicatively coupled to a database of the plurality of databases. In some embodiments, the one or more first control circuits can be further configured to update the first version of the distributed ledger to reflect a compliant performance of one or more of the contract provisions when the threshold number of third control circuits verify performance of the contract provision.

In some embodiments, one or more sensors can be communicatively coupled to the first control circuits and configured to monitor performance of the contract provisions. When the robotic node modifies the one or more robotic node functionalities, the first control circuits can be configured to use data generated by the sensors to identify the violation, generate one or more notifications of the violation using the received cryptographic key, where the generated notifications can include the robotic node's cryptographic signature. The first control circuits can also be configured to cause the robotic node to use a transceiver communicatively coupled to the first control circuit to transmit one or more notifications of the violation to the party and cause the robotic node to return one or more of the robotic node functionalities to their pre-modified states when an acknowledgement of the violation is received from the party.

In some embodiments, one or more transceivers can be communicatively coupled to the first control circuits. The first control circuits can be further configured to generate one or more notifications using the cryptographic key, where each generated notification comprises information corresponding to a cryptographic signature verifying the robotic node as a source of the generated notifications. The first control circuits can be further configured to cause the robotic node to use the transceiver to transmit the generated notifications to a threshold number of third control circuits to verify performance of the contract provisions, where each third control circuit can be communicatively coupled to one or more databases of the plurality of databases.

In some embodiments, the first control circuits can be further configured to update the first version of the distributed ledger to reflect each compliant performance of the one or more contract provisions when the threshold number of third control circuits verify the performance of the contract provisions. In some embodiments, one or more sensors may be communicatively coupled to the first control circuits and configured to monitor performance of the contract provisions. By one approach, when the first control circuits cause the robotic node to modify the one or more robotic node functionalities, the first control circuits may also be configured to use sensor data to identify the one or more violations. The first control circuits may also be configured to generate one or more notifications (e.g., comprising a cryptographic signature of the robotic node) of the violations using the received cryptographic key. The first control circuits may also be configured to cause the robotic node to use a transceiver communicatively coupled to the first control circuits to transmit one or more notifications of the one or more violations to the party. The first control circuits may also be configured to cause the robotic node to return the one or more robotic node functionalities to a pre-modified state when an acknowledgement of the one or more violations is received from the party.

In some embodiments, the second robotic node can be configured to act in a representative capacity on behalf of one or more of the parties and may enter in to the commercial agreement with the robotic node using a predetermined guideline specified by the robotic node. In some embodiments, the first control circuits can be configured to identify one or more second contract provisions of the commercial agreement, where the second contract provisions may each dictate one or more standard operational procedures (SOP) of an entity which the robotic node and the second robotic node are associated with.

In some embodiments, methods are provided for monitoring robotic node participation in peer-to-peer commercial transactions. Some of these methods access, through a robotic node participating in a peer-to-peer commercial transaction, one or more commercial agreements included in one or more distributed ledgers using one or more cryptographic keys unique to the accessed commercial agreements, each cryptographic key received from one or more second control circuits that are located external to the robotic node and associated with at least one party of the commercial agreement, where each commercial agreement comprises one or more contract provisions. The robotic node can be caused to activate one or more robotic node functionalities to facilitate one or more acts in performance of the one or more contract provisions. The robotic node can further be caused to modify one or more of the robotic node functionalities when a violation of one or more of the contract provisions is identified.

In some embodiments, the status of the performance of each of the contract provisions can be received from one or more objects. Each contract provision can include subject matter that can include one or more of the objects, which ca be configured to monitor performance of one or more of the contract provision. In some embodiments, one or more notifications can be generated using one or more of the cryptographic keys. By one approach, the generated notification can comprises information corresponding to the one or more acts and a cryptographic signature verifying the robotic node as the source of the generated notification. By one approach, the robotic node can be caused to transmit the generated notifications to a threshold number of third control circuits (e.g., communicatively coupled to a database comprising a version of the distributed ledger) to verify that the one or more acts satisfy performance of the one or more contract provisions.

In some embodiments, these methods can update one or more of the distributed ledgers to reflect compliant performance of the one or more acts when each of the threshold number of third control circuits verify that the one or more acts satisfy performance of the contract provision. In some embodiments, these methods can receive data (e.g., via a sensor communicatively coupled to the control circuit) about performance of the one or more contract provisions. The received data can be used to identify the one or more violations. One or more notifications of the violations (e.g., including a cryptographic signature of the robotic node) can be generated using the one or more cryptographic keys. The robotic node can be caused to transmit notifications of the violations to the one or more parties. The robotic node can be caused to return one or more of the robotic node functionalities to their pre-modified states when an acknowledgement of the violations is received from the one or more parties.

In some embodiments, the methods can identify one or more second contract provisions of the commercial agreement that are configured to be valid only when the presence of a human is absent within a threshold distance of the robotic node. The robotic node can be caused to activate one or more second robotic node functionalities to facilitate performance of the one or more second contract provisions when the presence of the human is absent within the threshold distance of the robotic node. By one approach, one or more second robotic nodes can act in a representative capacity on behalf of one or more of the parties and may enter in to the one or more commercial agreements using one or more predetermined guidelines specified by the robotic node.

In some embodiments, the methods can identify one or more second contract provisions of the commercial agreement that each dictate one or more standard operational procedures (SOPs) of one or more entities which the robotic node and the second robotic node are associated with. The robotic node can be caused to activate one or more second robotic node functionalities to facilitate performance of the one or more SOPs when the second robotic node acts in a representative capacity on behalf of one or more of the parties.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system to enable a robotic node to participate in peer-to-peer commercial transactions, comprising:
a plurality of databases each comprising information dictating a version of a distributed ledger comprising a commercial agreement, the commercial agreement comprising a contract provision; and
the robotic node comprising:
a first control circuit communicatively coupled to a first database included in the plurality of databases, the first database comprising a first version of the distributed ledger, and the first control circuit configured to:
access a commercial agreement of the first version of the distributed ledger using a cryptographic key for the commercial agreement and thereby cause the robotic node to activate a robotic node functionality to facilitate performance of the contract provision, the cryptographic key received from a second control circuit external to the robotic node and associated with a party of the commercial agreement; and
cause the robotic node to modify the robotic node functionality when a violation of the contract provision is identified.

2. The system of claim 1, wherein
a subject matter of the contact provision comprises an object,
the object comprises:
a transceiver
a third control circuit communicatively coupled to the transceiver and a third database of the plurality of databases, and configured to:
monitor the performance of the contract provision; and
transmit, via the transceiver, a status of the performance to a threshold number of fourth control circuits to verify performance of the contract provision, each fourth control circuit communicatively coupled to a fourth database of the plurality of databases.

3. The system of claim 1, wherein the robotic node further comprises:
a transceiver communicatively coupled to the first control circuit; and
wherein the first control circuit is further configured to:
generate a notification using the cryptographic key, the generated notification comprising information corresponding to a cryptographic signature verifying the robotic node as a source of the generated notification; and
cause the robotic node to transmit, via the transceiver, the generated notification to a threshold number of third control circuits to verify performance of the contract provision, each third control circuit communicatively coupled to a database of the plurality of databases.

4. The system of claim 3, wherein the first control circuit is further configured to update the first version of the distributed ledger to reflect a compliant performance of the contract provision when the threshold number of third control circuits verify performance of the contract provision.

5. The system of claim 1, wherein the robotic node further comprises:
a sensor communicatively coupled to the first control circuit and configured to monitor performance of the contract provision; and
wherein in causing the robotic node to modify the robotic node functionality the first control circuit is configured to:
identify, using sensor data, the violation;
generate a notification of the violation using the received cryptographic key, the generated notification comprising a cryptographic signature of the robotic node;
cause the robotic node to transmit, via a transceiver communicatively coupled to the first control circuit, a notification of the violation to the party; and
cause the robotic node to return the robotic node functionality to a pre-modified state when an acknowledgement of the violation is received from the party.

6. The system of claim 1, wherein the control circuit is further configured to:
identify a second contract provision of the commercial agreement that is configured to be valid only when a presence of a human is absent within a threshold distance of the robotic node; and
cause the robotic node to activate a second robotic node functionality to facilitate performance of the second contract provision when the presence of the human is absent within the threshold distance of the robotic node.

7. The system of claim 1, wherein a second robotic node acts in a representative capacity on behalf of the party and enters in to the commercial agreement with the robotic node using a predetermined guideline specified by the robotic node.

8. The system of claim 7, wherein the first control circuit is configured to:
identify a second contract provision of the commercial agreement, the second contract provision dictates a standard operational procedure (SOP) of an entity which the robotic node and the second robotic node are associated with; and
cause the robotic node to activate a second robotic node functionality to facilitate performance of the SOP when the second robotic node acts in a representative capacity on behalf of the party.

9. A method to enable robotic node participation in peer-to-peer commercial transactions, comprising:
accessing, via a control circuit, a commercial agreement included in a distributed ledger using a cryptographic key for the accessed commercial agreement, the cryptographic key received from a second control circuit external to the robotic node and associated with a party of the commercial agreement, the commercial agreement comprising a contract provision;
causing, via the control circuit, the robotic node to activate a robotic node functionality to facilitate an act in performance of the contract provision; and
causing, via the control circuit, the robotic node to modify the robotic node functionality when a violation of the contract provision is identified.

10. The method of claim 9, further comprising receiving, via the control circuit, a status of the performance of the contract provision from an object, the contract provision comprising subject matter, the subject matter comprising the object, the object configured to monitor performance of the contract provision.

11. The method of claim 9, further comprising:
generating, via the control circuit, a notification using the cryptographic key, the generated notification comprising information corresponding to the act and a cryptographic signature verifying the robotic node as a source of the generated notification; and
causing, via the control circuit, the robotic node to transmit the generated notification to a threshold number of third control circuits to verify that the act satisfies performance of the contract provision, each third control circuit communicatively coupled to a database comprising a version of the distributed ledger.

12. The method of claim 11, further comprising updating, via the control circuit, the distributed ledger to reflect a compliant performance of the act when each of the threshold number of third control circuits verify that the act satisfies performance of the contract provision.

13. The method of claim 9, wherein causing the robotic node to modify the robotic node functionality comprises:
receiving, via a sensor communicatively coupled to the control circuit, data about performance of the contract provision;
using, via the control circuit, the received data to identify the violation;
generating, via the control circuit, a notification of the violation using the cryptographic key, the notification comprising a cryptographic signature of the robotic node;
causing, via the control circuit, the robotic node to transmit the notification of the violation to the party; and
causing, via the control circuit, the robotic node to return the robotic node functionality to a pre-modified state when an acknowledgement of the violation is received from the party.

14. The method of claim 9, further comprising:
identifying, via the control circuit, a second contract provision of the commercial agreement that is configured to be valid only when a presence of a human is absent within a threshold distance of the robotic node; and
causing, via the control circuit, the robotic node to activate a second robotic node functionality to facilitate performance of the second contract provision when the presence of the human is absent within the threshold distance of the robotic node.

15. The method of claim 9, wherein a second robotic node acts in a representative capacity on behalf of the party and enters in to the commercial agreement using a predetermined guideline specified by the robotic node.

16. The method of claim 15, further comprising:
identifying, via the control circuit, a second contract provision of the commercial agreement, the second contract provision dictating a standard operational procedure (SOP) of an entity which the robotic node and the second robotic node are associated with; and
causing, via the control circuit, the robotic node to activate a second robotic node functionality to facilitate performance of the SOP when the second robotic node acts in a representative capacity on behalf of the party.
